(19) United States
(12) Patent Application Publication
(10) Pub. No.: US 2007/0290166 A1
(43) Pub. Date: Dec. 20, 2007

(54) METHOD AND COMPOSITION FOR POLISHING A SUBSTRATE

(76) Inventors: Feng Q. Liu, San Jose, CA (US); Tianbao Du, Beaverton, OR (US); Alain Duboust, Sunnyvale, CA (US); Wei-Yung Hsu, Santa Clara, CA (US)

Correspondence Address: PATTERSON & SHERIDAN, LLP, 3040 POST OAK BOULEVARD, SUITE 1500, HOUSTON, TX, 77056, US

(21) Appl. No.: 11/838,512

(22) Filed: Aug. 14, 2007

Related U.S. Application Data
(63) Continuation-in-part of application No. 11/356,352, filed on Feb. 15, 2006.
(63) Continuation-in-part of application No. 11/196,876, filed on Aug. 4, 2005.
Application No. 11/196,876 is a continuation-in-part of application No. 11/123,174, filed on May 6, 2005.
Application No. 11/123,174 is a continuation-in-part of application No. 10/845,754, filed on May 14, 2004.
Application No. 10/845,754 is a continuation-in-part of application No. 10/608,404, filed on Jun. 26, 2003, now Pat. No. 7,160,432.
Application No. 10/845,754 is a continuation-in-part of application No. 10/456,220, filed on Jun. 6, 2003, now Pat. No. 7,232,514.
Application No. 10/456,220 is a continuation-in-part of application No. 10/378,097, filed on Feb. 26, 2003, now Pat. No. 7,128,825.
Application No. 10/456,220 is a continuation-in-part of application No. 10/038,066, filed on Jan. 3, 2002, now Pat. No. 6,811,680.
(60) Provisional application No. 60/822,359, filed on Aug. 14, 2006.
(60) Provisional application No. 60/729,009, filed on Oct. 21, 2005.
(60) Provisional application No. 60/359,746, filed on Feb. 26, 2002.
(60) Provisional application No. 60/275,874, filed on Mar. 14, 2001.

(51) Int. Cl. C09K 13/04

(52) U.S. Cl. 252/79.2; 252/79.1

(57) ABSTRACT

Compositions and processes for producing compositions for removing conductive material, such as copper or copper alloys, from a substrate with reduced dishing and reduced insensitivity to overpolishing are provided. Embodiments include polishing compositions for electrochemical mechanical polishing of a substrate surface comprising a conductive material, the compositions having a pH of between about 3.0 to about 9.0, such as between about 4.0 to about 7.0, for example between about 5.0 to about 6.5. The polishing compositions comprise one or more inorganic based electrolytes, such as potassium phosphate monobasic, one or more chelating agents, such as citric acid, imidodiacetic acid, glycine, or salts thereof, such as ammonium citrate, one or more corrosion inhibitors, such as benzotriazole, a basic pH adjusting agent, such as ammonium hydroxide, potassium hydroxide or combinations thereof, one or more oxidizers, such as hydrogen peroxide or ammonium persulphate (APS), and a solvent, such as deionized water.

### CROSS-REFERENCE TO RELATED APPLICATIONS

This application claims benefit of U.S. Provisional Patent Application Ser. No. 60/822,359, filed Aug. 14, 2006. This application is a continuation-in-part of co-pending U.S. patent application Ser. No. 11/356,352 (5699.P9), filed Feb. 15, 2006, which claims benefit to U.S. Provisional Patent Application Ser. No. 60/729,009, filed on Oct. 21, 2005, and is a continuation-in-part of co-pending U.S. patent application Ser. No. 11/196,876 (5699.P6), filed Aug. 4, 2005, which application is a continuation-in-part of co-pending U.S. patent application Ser. No. 11/123,174 (5699.P5), filed May 5, 2005, which application is a continuation-in-part of co-pending U.S. patent application Ser. No. 10/845,754 (5699.P4), filed May 14, 2004, which application is a continuation-in-part of co-pending U.S. patent application Ser. No. 10/608,404 (5699.P3), filed Jun. 26, 2003, now U.S. Pat. No. 7,160,432, issued Jan. 9, 2007, which application is a continuation-in-part of co-pending U.S. patent application Ser. No. 10/456,220 (5699.P2), filed Jun. 6, 2003, now U.S. Pat. No. 7,232,514, issued Jun. 19, 2007, which application is a continuation-in-part of co-pending U.S. patent application Ser. No. 10/378,097 (5699.P1), filed Feb. 26, 2003, now U.S. Pat. No. 7,128,825, issued Oct. 31, 2006, which application claims priority to the U.S. Provisional Patent Application Ser. No. 60/359,746, filed on Feb. 26, 2002, and which U.S. patent application Ser. No. 10/378,097 is a continuation-in-part of U.S. patent application Ser. No. 10/038,066 (5699), filed Jan. 3, 2002, now U.S. Pat. No. 6,811,680, issued on Nov. 2; 2004, which application claims priority to the U.S. Provisional Patent Application Ser. No. 60/275,874, filed on Mar. 14, 2001, which applications are herein incorporated by reference.

### BACKGROUND OF THE INVENTION

1. Field of the Invention

Embodiments of the present invention relate to compositions and methods for removing a conductive material from a substrate.

2. Description of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process where material is removed from the surface of the substrate to form a generally even, planar surface. Planarization is useful in removing excess deposited material, removing undesired surface topography, and surface defects, such as surface roughness, agglomerated materials, crystal lattice damage, scratches and contaminated layers or materials to provide an even surface for subsequent photolithography and other semiconductor processes.

Chemical mechanical planarization or chemical mechanical polishing (CMP) is a common technique used to planarize substrates. In conventional CMP techniques, a substrate carrier or polishing head is mounted on a carrier assembly and positioned in contact with a polishing article in a CMP apparatus. The carrier assembly provides a controllable pressure to the substrate urging the substrate against the polishing pad. The pad is moved relative to the substrate by an external driving force. Thus, the CMP apparatus effects polishing or rubbing movement between the surface of the substrate and the polishing article while dispersing a polishing composition to effect both chemical activity and mechanical activity.

However, materials deposited on the surface of a substrate to fill feature definitions formed therein often result in unevenly formed surfaces over feature definitions of variable density. Referring to FIG. 1A, a metal layer 20 is deposited on a substrate 10 to fill wide feature definitions 30, also known as low density feature definitions, or narrow feature definitions 40, also known as high density feature definitions. Excess material, called overburden, may be formed with a greater thickness 45 over the narrow feature definitions 40 and may have minimal deposition 35 over wide feature definitions 30. Polishing of surfaces with overburden may result in the retention of residues 50 from inadequate metal removal over narrow features. Overpolishing processes to remove such residues 50 may result in excess metal removal over wide feature definitions 30. Excess metal removal can form topographical defects, such as concavities or depressions known as dishing 55, over wide features, as shown in FIG. 1B.

Dishing of features and retention of residues on the substrate surface are undesirable since dishing and residues may detrimentally affect subsequent processing of the substrate. For example, dishing results in a non-planar surface that impairs the ability to print high-resolution lines during subsequent photolithographic steps and detrimentally affects subsequent surface topography of the substrate, which affects device formation and yields. Dishing also detrimentally affects the performance of devices by lowering the conductance and increasing the resistance of the devices, causing device variability and device yield loss. Residues may lead to uneven polishing of subsequent materials, such as barrier layer materials (not shown) disposed between the conductive material and the substrate surface. Post CMP profiles generally show higher dishing on wide trenches than on narrow trenches or dense areas. Uneven polishing will also increase defect formation in devices and reduce substrate yields.

Therefore, there exists a need for compositions and methods for removing conductive material, such as copper or copper alloys, from a substrate with reduced dishing and reduced insensitivity to overpolishing.

### SUMMARY OF THE INVENTION

Embodiments provide compositions and methods for removing conductive material, such as copper or copper alloys, from a substrate with reduced dishing and reduced insensitivity to overpolishing.

In one embodiment, a composition having a pH of about 3.0 to about 9.0 for electrochemical mechanical polishing of a substrate surface comprising a conductive material is provided. The composition comprises one or more inorganic based electrolytes, a first chelating agent having one or more carboxylate functional groups, a second chelating agent having an amine functional group, one or more corrosion inhibitors, a basic pH adjusting agent, and a solvent. In another embodiment, the composition further comprises one or more oxidizers, such as hydrogen peroxide or ammonium persulphate.

In another embodiment, a composition for electrochemical mechanical polishing of a substrate surface comprising a conductive material, may be produced by the process of combining a phosphoric acid based electrolyte system with one or more chelating agents, one or more corrosion inhibitors, one or more oxidizers, and a solvent, and adding one or more basic pH adjusting agents to the phosphoric acid based electrolyte system to achieve a pH from about 3.0 to about 9.0 is provided.

In another embodiment, a method of manufacturing a composition for electrochemical mechanical polishing of a substrate surface is provided. The method of manufacturing comprises providing a phosphoric acid based system, adding one or more chelating agents to the phosphoric acid based system, adding one or more oxidizers to the phosphoric acid based system, adding one or more basic pH adjusting agents to the phosphoric acid based system to achieve a pH between about 3.0 and about 9.0, and adding a solvent to the phosphoric acid based system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1B (Prior Art) are schematic cross-sectional views illustrating a polishing process performed on a substrate according to conventional processes;

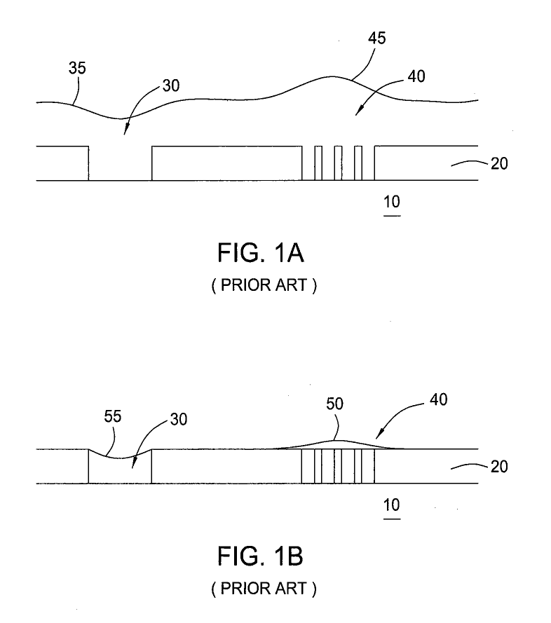

FIG. 2 is a plan view of an electrochemical mechanical planarizing system;

FIG. 3 is a flow chart illustrating the processing steps according to one embodiment of the invention; and

FIGS. 4A-4E are schematic cross-sectional views illustrating a polishing process performed on a substrate according to one embodiment of the invention.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

In general, aspects of the inventions provide compositions, methods for producing compositions, and methods for removing at least a conductive material, such as copper or copper alloys, from a substrate surface. The inventions are described below in reference to a planarizing process for the removal of conductive materials from a substrate surface by an electrochemical mechanical polishing (Ecmp) technique.

The words and phrases used herein should be given their ordinary and customary meaning in the art by one skilled in the art unless otherwise further defined. Chemical mechanical polishing should be broadly construed and includes, but is not limited to, planarizing a substrate surface using chemical activity and mechanical activity, or a concurrent application of chemical activity and mechanical activity. Electropolishing should be broadly construed and includes, but is not limited to, removing material from a substrate by eroding the substrate surface under application of current. Electrochemical mechanical polishing (Ecmp) should be broadly construed and includes, but is not limited to, planarizing a substrate by the application of electrochemical activity, mechanical activity, chemical activity, or a concurrent application of a combination of electrochemical, chemical, and/or mechanical activity to remove material from a substrate surface.

Anodic dissolution should be broadly construed and includes, but is not limited to, the application of an anodic bias to a substrate directly or indirectly which results in the removal of conductive material from a substrate surface and into a surrounding polishing composition. Polishing composition should be broadly construed and includes, but is not limited to, a composition that provides ionic conductivity, and thus, electrical conductivity, in a liquid medium, which generally comprises materials known as electrolyte components. The amount of each electrolyte component in polishing compositions can be measured in volume percent or weight percent. Volume percent refers to a percentage based on volume of a desired liquid component divided by the total volume of all of the liquid in the complete composition. A percentage based on weight percent is the weight of the desired component divided by the total weight of all of the liquid components in the complete composition. Abrading and abrasion should be broadly construed and includes, but is not limited to, contacting a material and displacing, disturbing, or removing all or a portion of a material.

The electrochemical mechanical polishing process may be performed in a process apparatus, such as a platform having one or more polishing stations adapted for electrochemical mechanical polishing processes. The one or more polishing stations may be adapted to perform conventional chemical mechanical polishing. A platen for performing an electrochemical mechanical polishing process may include a polishing article, a first electrode, and a second electrode, wherein the substrate is in electrical contact with the second electrode. An example of a suitable system is the REFLEXION LK Ecmp™ processing system, commercially available from Applied Materials, Inc., of Santa Clara, Calif. The following apparatus description is illustrative and should not be construed or interpreted as limiting the scope of the invention.

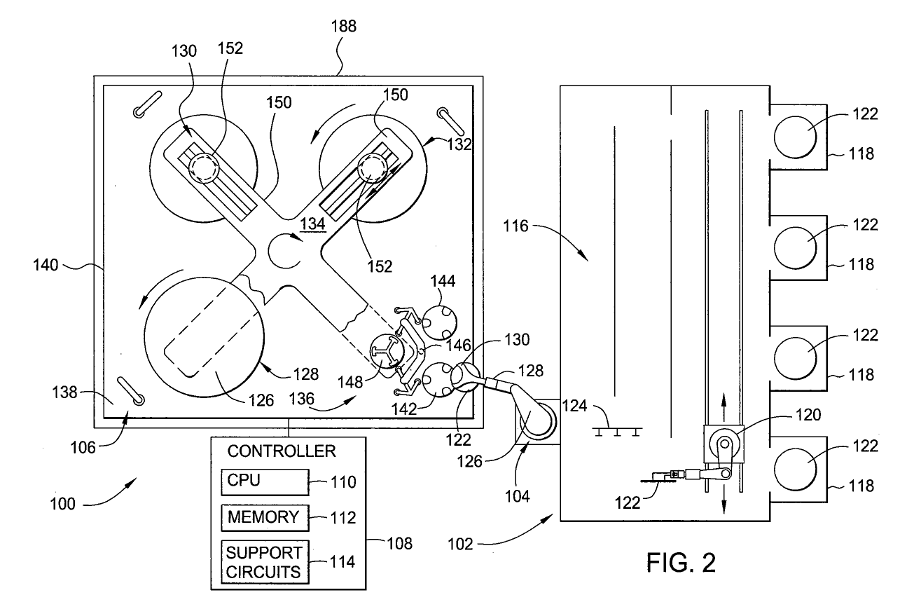

FIG. 2 is a plan view of one embodiment of an exemplary planarization system 100 having an apparatus for electrochemically processing a substrate. The planarization system 100 generally comprises a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the planarization system 100. The controller 108 comprises a central processing unit (CPU) 110, a memory 112, and support circuits 114. The controller 108 is coupled to the various components of the planarization system 100 to facilitate control of, for example, the planarizing, cleaning, and transfer processes.

The factory interface 102 generally includes a cleaning module 116 and one or more wafer cassettes 118. An interface robot 120 is employed to transfer substrates 122 between the wafer cassettes 118, the cleaning module 116 and an input module 124. The input module 124 is positioned to facilitate transfer of substrates 122 between the planarizing module 106 and the factory interface 102 by grippers, for example vacuum grippers or mechanical clamps (not shown).

The planarizing module 106 includes at least a first electrochemical mechanical planarizing (Ecmp) station 128, disposed in an environmentally controlled enclosure 188. Examples of planarizing modules 106 that can be adapted to benefit from the invention include MIRRA® Chemical Mechanical Planarizing Systems, MIRRA MESA® Chemical Mechanical Planarizing Systems, REFLEXION® Chemical Mechanical Planarizing Systems, REFLEXION® LK Chemical Mechanical Planarizing Systems, and REFLEXION LK Ecmp™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

In the embodiment depicted in FIG. 2, the planarizing module 106 includes a first Ecmp station 128, a second Ecmp station 130 and third polishing station 132. The third polishing station may be an Ecmp station as described for Ecmp stations 128 or 130 as shown in FIG. 2, and alternatively, may be a chemical mechanical polishing (CMP) station. As CMP stations are conventional in nature, further description thereof has been omitted for the sake of brevity. However, an example of a suitable CMP polishing station is more fully described in U.S. Pat. No. 5,738,574, issued on Apr. 14, 1998, entitled, “Continuous Processing System for Chemical Mechanical Polishing,” the entirety of which is incorporated herein by reference to the extent not inconsistent with the invention.

Initial removal of a first portion of the conductive material, bulk material removal, from the substrate is performed through an electrochemical dissolution process at the Ecmp station 128. After the bulk material removal at the first Ecmp station 128, removal of a second portion of the conductive material, residual conductive material removal, is performed at the second Ecmp station 130 through a second electrochemical mechanical process. It is contemplated that more than one residual Ecmp stations may be utilized in the planarizing module 106. Barrier layer material may be removed at polishing station 132 after processing at the second Ecmp station 130 by the barrier removal processes described herein. Alternatively, each of the first and second Ecmp stations 128, 130 may be utilized to perform both the two-step conductive material removal as described herein on a single station.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

The carousel 134 is centrally disposed on the base 140. The carousel 134 typically includes a plurality of arms 150, each supporting a planarizing head assembly 152. Two of the arms 150 depicted in FIG. 2 are shown in phantom such that the transfer station 136 and a polishing article assembly 126 of the first Ecmp station 128 may be seen. The carousel 134 is indexable such that the planarizing head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

Polishing Composition

Although the polishing compositions are particularly useful for removing copper, the polishing compositions also may be used for the removal of other conductive materials, such as aluminum, platinum, tungsten, titanium, titanium nitride, tantalum, tantalum nitride, cobalt, gold, silver, ruthenium or combinations thereof.

Novel polishing compositions described herein for electrochemical mechanical polishing of a substrate surface comprising conductive materials, such as metals, including copper, may comprise one or more inorganic based electrolytes, one or more chelating agent, one or more corrosion inhibitors, a basic pH adjusting agent, one or more oxidizers, and a solvent.

The one or more inorganic based electrolytes provide a suitable pH for chemical reactions of the composition described herein. Suitable acid based electrolyte systems include, for example, phosphoric acid based electrolytes, sulfuric acid, nitric acid, perchloric acid, or combinations thereof. The inorganic acid based electrolyte systems include acid electrolyte derivatives, including ammonium, potassium, sodium, calcium and copper salts thereof. The acid based electrolyte system may also buffer the composition to maintain a desired pH level for processing a substrate.

Examples of suitable acid based electrolytes include compounds having a phosphate group (PO₄³⁻), such as, phosphoric acid, copper phosphate, potassium phosphates (KₓH₍₃₋ₓ₎PO₄) (x=1, 2 or 3), such as potassium dihydrogen phosphate (KH₂PO₄), dipotassium hydrogen phosphate (K₂HPO₄), ammonium phosphates ((NH₄)ₓH₍₃₋ₓ₎PO₄) (x=1, 2 or 3), such as ammonium dihydrogen phosphate ((NH₄)H₂PO₄), diammonium hydrogen phosphate ((NH₄)₂HPO₄), compounds having a nitrite group (NO₃¹⁻), such as, nitric acid or copper nitrate, compounds having a boric group (BO₃³⁻), such as, orthoboric acid (H₃BO₃) and compounds having a sulfate group (SO₄²⁻), such as sulfuric acid (H₂SO₄), ammonium hydrogen sulfate ((NH₄)HSO₄), ammonium sulfate, potassium sulfate, copper sulfate, derivatives thereof or combinations thereof. The invention also contemplates that conventional electrolytes known and unknown may also be used in forming the composition described herein using the processes described herein.

The acid based electrolyte system contains an acidic component that can take up about 1 to about 30 percent by weight (wt. %) or volume (vol. %), for example, between about 4 wt. % and about 15 wt. %, such as between about 8 wt. % and 13 wt. %, of the total composition of solution to provide suitable conductivity for practicing the processes described herein.

One aspect or component of the present invention is the use of one or more chelating agents to complex with the surface of the substrate to enhance the electrochemical dissolution process. In any of the embodiments described herein, the chelating agents can bind to a conductive material, such as copper ions, increase the removal rate of metal materials and/or improve dissolution uniformity across the substrate surface. The metal materials for removal, such as copper, may be in any oxidation state, such as 0, 1, or 2, before, during or after ligating with a functional group. The functional groups can bind the metal materials created on the substrate surface during processing and remove the metal materials from the substrate surface. The chelating agents may also be used to buffer the polishing composition to maintain a desired pH level for processing a substrate. The chelating agents may also form or enhance the formation of a passivation layer on the substrate surface.

In one embodiment the one or more chelating agents comprises a first chelating agent having a carboxylate functional group and a second chelating agent having an amine or amide functional group. The chelating agent having a carboxylate functional group include compounds having one or more functional groups selected from the group of carboxylate functional groups, dicarboxylate functional groups, tricarboxylate functional groups, a mixture of hydroxyl and carboxylate functional groups, or combinations thereof. The one or more chelating agents may also include salts of the chelating agents described herein, for example, ammonia and potassium salts thereof. The first chelating agent having the carboxylate functional group may be in the composition at a concentration between about 0.4 wt. % and about 2.5 wt. %, such as between about 1 wt. % and about 2 wt. % of the composition.

Examples of suitable first chelating agents having one or more carboxylate functional groups include citric acid, tartaric acid, succinic acid, oxalic acid, amino acids, salts thereof, or combinations thereof. For example, suitable salts for the chelating agent may include ammonium citrate, potassium citrate, ammonium succinate, potassium succinate, ammonium oxalate, potassium oxalate, potassium tartrate, or combinations thereof. The salts may have multi-basic states, for example, citrates have mono-, di- and tri-basic states. Other suitable chelating agents having one or more carboxylate functional groups include acetic acid, adipic acid, butyric acid, capric acid, caproic acid, caprylic acid, glutaric acid, glycolic acid, formaic acid, fumaric acid, lactic acid, lauric acid, malic acid, maleic acid, malonic acid, myristic acid, palmitic acid, phthalic acid, propionic acid, pyruvic acid, stearic acid, valeric acid, derivatives thereof, salts thereof or combinations thereof. Suitable first chelating agents may be free of an amine or amide functional groups.

In another embodiment, the one or more chelating agents comprise a second chelating agent in addition to the first chelating agent. The second chelating agent having an amine or amide functional group can include compounds such as ethylenediamine (EDA), diethylenetriamine, diethylenetriamine derivatives, hexadiamine, amino acids, glycine, methylformamide, imidodiacetic acid, derivatives thereof, salts thereof or combinations thereof. The chelating agent having an amine or amide functional group may be in the composition at a concentration between about 0.2 wt. % and about 3.0 wt. %, such as between about 0.5 wt. % and about 1.5 wt. % of the composition.

Another aspect or component of the current invention is the use of one or more corrosion inhibitors. The corrosion inhibitors can be added to reduce the oxidation or corrosion of metal surfaces by forming a passivation layer that minimizes the chemical interaction between the substrate surface and the surrounding electrolyte. The layer of material formed by the corrosion inhibitors thus tends to suppress or minimize the electrochemical current from the substrate surface to limit electrochemical deposition and/or dissolution.

Examples of suitable corrosion inhibitors include corrosion inhibitors having an azole group. Examples of organic compounds having azole groups include benzotriazole (BTA), mercaptobenzotriazole, 5-methyl-1-benzotriazole (TTA), tolyltriazole (TTA), derivatives thereof or combinations thereof. Other suitable compounds include 1,2,4 triazole, benzoylimidazole (BIA), benzimidazole, derivatives thereof or combinations thereof.

Another aspect or component of the present invention includes one or more basic pH adjusting agents to achieve a pH of between about 3.0 to about 9.0, such as between about 4.0 to about 7.0, for example between about 5.0 to about 6.5. Examples of suitable basic pH adjusting agents include hydroxides, such as potassium hydroxide, ammonium hydroxide, or combinations thereof. The one or more basic pH adjusting agents may be in the composition at a concentration between about 0.1 vol. % and about 10.0 vol. %, such as between about 0.5 vol. % and about 6.0. vol. % of the composition.

Another aspect or component of the present invention includes one or more oxidizers. Examples of suitable oxidizers include hydrogen peroxide, ferric nitrate, an iodate, or ammoniumpersulphate (APS) and can be present at a concentration between about 0.01 wt. % and about 1 wt. %, such as between about 0.03 wt. % and about 0.18 wt. %.

Another aspect or component of the present invention may comprise conventional abrasive particles, such as silica or modified silica with a particle size from between about 5 nm to about 100 nm.

The balance or remainder of the polishing compositions described herein is a solvent, such as a polar solvent, including water, such as deionized water. Other solvents may be used solely or in combination with water, such as organic solvents. Organic solvents include alcohols, such as isopropyl alcohol or glycols, ethers, such as diethyl ether, furans, such as tetrahydrofuran, hydrocarbons, such as pentane or heptane, aromatic hydrocarbons, such as benzene or toluene, halogenated solvents, such as methylene chloride or carbon tetrachloride, derivatives, thereof or combinations thereof.

The compositions herein may have a pH between about 3.0 and about 9.0, such as between about 4.0 to about 7.0, for example between about 5.0 to about 6.5.

### EXAMPLES

The following non-limiting examples are provided to further illustrate embodiments of the invention. However, the examples are not intended to be all-inclusive and are not intended to limit the scope of the inventions described herein.

An example of the a polishing composition for the bulk removal of copper or copper alloys includes about 4-15 wt. % potassium phosphate monobasic, for example 8-13 wt. % potassium phosphate monobasic, about 0.4-2.5 wt. % citric acid, for example about 1-2 wt. % citric acid, about 0.1-0.4 wt. % benzotriazole (BTA), for example about 0.3% BTA, between about 0.5% and about 6% by volume potassium hydroxide solution to achieve a pH of about 3.0 to about 9.0, such as between about 4.0 to about 7.0, for example between about 5.0 to about 6.5; about 0.01-1 wt. % hydrogen peroxide; about 0.01-1 wt. % of silica (SiO₂) abrasive particles; and the remainder de-ionized water. In another example, the citric acid is replaced with about 0.4-2.5 wt. % ammonium citrate, for example 1-2 wt. % ammonium citrate. This polishing composition may also be used for the residual removal of copper. The invention also contemplates dilution of this polishing composition by 1-500% for use in the residual removal of copper. The composition may be diluted with deionized water, deionized water with BTA, deionized water with a polymer such as polyethylene glycol (PEG), polyethylene oxide (PEO), polycarboxylic acid, and polyamide, or deionized water with a surfactant such as ammonium dodecyl sulfate (ADS).

Another example of a polishing composition for the bulk removal of copper or copper alloys includes about 4-15 wt. % potassium phosphate monobasic, for example 8-13 wt. % potassium phosphate monobasic, about 0.5-2% nitric acid, for example about 1% nitric acid, about 0.4-2.5 wt. % citric acid, for example about 1-2 wt. % citric acid, about 0.1-0.4 wt. % benzotriazole (BTA), for example about 0.3% BTA, between about 0.5% and about 6% by volume potassium hydroxide solution to achieve a pH of about 4 to about 7, for example a pH of about 5 to about 6.5; about 0.01-1 wt. % hydrogen peroxide; about 0.01-1 wt. % of silica (SiO₂) abrasive particles; and the remainder de-ionized water. In another example, the citric acid is replaced with about 0.4-2.5 wt. % ammonium citrate, for example 1-2 wt. % ammonium citrate. This polishing composition may also be used for the residual removal of copper. The invention also contemplates dilution of this polishing composition by 1-500% for use in the residual removal of copper. The composition may be diluted with deionized water, deionized water with BTA, deionized water with a polymer such as PEG, PEO, polycarboxylic acid, and polyamide, or deionized water with a surfactant such as ADS.

Another example of a polishing composition for the bulk removal of copper or copper alloys includes about 4-15 wt. % potassium phosphate monobasic, for example 8-13 wt. % potassium phosphate monobasic, about 0.4-2.5 wt. % citric acid, for example 1-2 wt. % weight citric acid, about 0.2-3 wt. % imidodiacetic acid, for example 0.2-1.5 wt. % imidodiacetic acid, about 0.1-0.4 wt. % BTA, for example 0.3 wt. % BTA, between about 0.5% and about 6% by volume potassium hydroxide solution to achieve a pH of about 3.0 to about 9.0, such as between about 4.0 to about 7.0, for example between about 5.0 to about 6.5, about 0.01-1 wt. % hydrogen peroxide, about 0.01-1% by weight of silica (SiO₂) abrasive particles; and the remainder de-ionized water. In another example, the citric acid is replaced with about 0.4-2.5 wt. % ammonium citrate, for example 1-2 wt. % ammonium citrate. This polishing composition may also be used for the residual removal of copper. The invention also contemplates dilution of this polishing composition by 1-500% for use in the residual removal of copper. The composition may be diluted with deionized water, deionized water with BTA, deionized water with a polymer such as PEG, PEO, polycarboxylic acid, and polyamide, or deionized water with a surfactant such as ADS.

Another example of a polishing composition for the bulk removal of copper or copper alloys includes about 4-15 wt. % potassium phosphate monobasic, for example 8-13 wt. % potassium phosphate monobasic, about 0.4-2.5 wt. % succinic acid, for example about 1-2 wt. % succinic acid, about 0.1-0.4 wt. % benzotriazole (BTA), for example about 0.3% BTA, between about 0.5% and about 6% by volume potassium hydroxide solution to achieve a pH of about 4 to about 7, for example a pH of about 5 to about 6.5; about 0.01-1 wt. % hydrogen peroxide; about 0.01-1 wt. % of silica (SiO₂) abrasive particles; and the remainder de-ionized water. In another example, the citric acid is replaced with about 0.4-2.5 wt. % ammonium citrate, for example 1-2 wt. % ammonium citrate. This polishing composition may also be used for the residual removal of copper. The invention also contemplates dilution of this polishing composition by 1-500% for use in the residual removal of copper. The composition may be diluted with deionized water, deionized water with BTA, deionized water with a polymer such as PEG, PEO, polycarboxylic acid, and polyamide, or deionized water with a surfactant such as ADS.

Another example of a polishing composition for the bulk removal of copper or copper alloys includes about 4-15 wt. % potassium phosphate monobasic, for example 8-13 wt. % potassium phosphate monobasic, about 0.4-2.5 wt. % citric acid, for example 1-2 wt. % weight citric acid, about 0.2-3 wt. % glycine, for example 0.2-1.5 wt. % glycine, about 0.1-0.4 wt. % BTA, for example 0.3 wt. % BTA, between about 0.5% and about 6% by volume potassium hydroxide solution to achieve a pH of about 3.0 to about 9.0, such as between about 4.0 to about 7.0, for example between about 5.0 to about 6.5, about 0.01-1 wt. % hydrogen peroxide, about 0.01-1% by weight of silica (SiO₂) abrasive particles; and the remainder de-ionized water. In another example, the citric acid is replaced with about 0.4-2.5 wt. % ammonium citrate, for example 1-2 wt. % ammonium citrate. This polishing composition may also be used for the residual removal of copper. The invention also contemplates dilution of this polishing composition by 1-500% for use in the residual removal of copper. The composition may be diluted with deionized water, deionized water with BTA, deionized water with a polymer such as PEG, PEO, polycarboxylic acid, and polyamide, or deionized water with a surfactant such as ADS.

Polishing Process

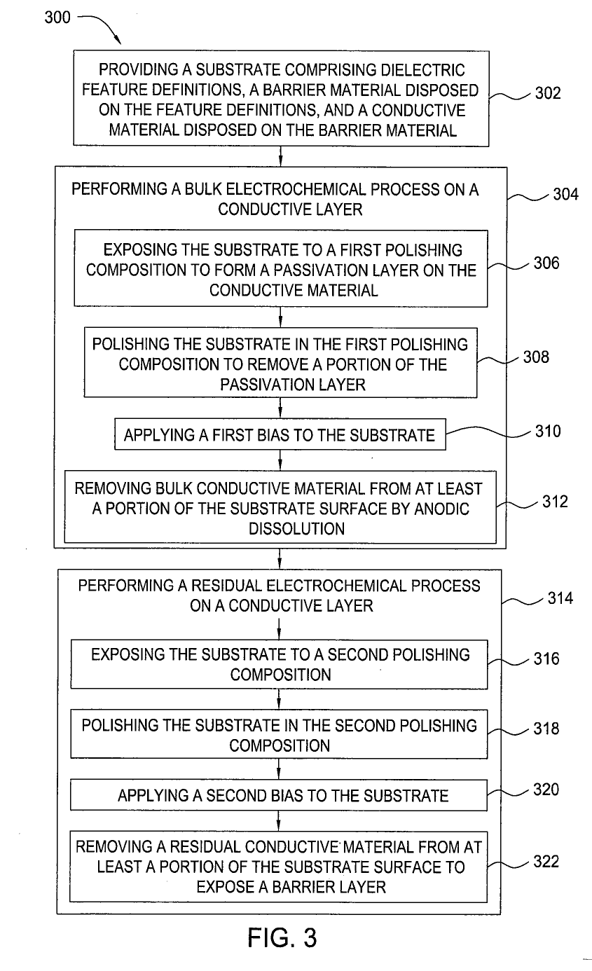

FIG. 3 depicts one embodiment of a method 300 for electroprocessing a substrate having an exposed conductive layer and an underlying barrier layer that may be practiced on the system 100 described above. The conductive layer may be tungsten, copper, a layer having both exposed tungsten and copper, and the like. The barrier layer may be ruthenium, tantalum, tantalum nitride, titanium, titanium nitride, and the like. A dielectric layer, typically an oxide, generally underlies the barrier layer. The method 300 may also be practiced on other electroprocessing systems, including those from other manufacturers. The method 300 is generally stored in the memory 112 of the controller 108, typically as a software routine. The software routine may also be stored and/or executed by a second CPU (not shown) that is remotely located from the hardware being controlled by the CPU 110.

Although the process of the present invention is discussed as being implemented as a software routine, some of the method steps that are disclosed therein may be performed in hardware as well as by the software controller. As such, the invention may be implemented in software as executed upon a computer system, in hardware, as an application specific integrated circuit or other type of hardware implementation, or a combination of software and hardware.

The method 300 begins at step 302 by providing a substrate 122 comprising dielectric feature definitions, a barrier material disposed on the feature definitions, and a conductive material disposed on the barrier material. In one embodiment, the conductive layer is a layer of copper about 3000 to about 10000 Å thick.

Next, at step 304, a bulk electrochemical process is performed on the conductive layer formed on the substrate 122. The bulk process step 304 is performed at the first ECMP station 128. The bulk process step 304 generally is terminated when the conductive layer is about 500 to about 1500 Å thick.

In one embodiment, the bulk electrochemical process of step 304 begins at step 306 by exposing the substrate 122 to a first polishing composition to form a passivation layer on the conductive material. The first polishing composition comprises one or more inorganic based electrolytes, one or more chelating agents, one or more corrosion inhibitors, one or more basic pH adjusting agents, a solvent, and one or more oxidizers as discussed above.

At step 308, the substrate 122 is polished in the first polishing composition to remove a portion of the passivation layer. Relative motion is provided between the substrate 122 and a polishing article (not shown). In one embodiment, the planarizing head is rotated at about 10-50 revolutions per minute, while the pad assembly (not shown) is rotated at about 7-35 revolutions per minute.

At step 310, a power source (not shown) provides a first bias voltage to the substrate 122 between the top surface of the pad assembly (not shown) and the electrode (not shown). In one embodiment, the first bias comprises a voltage held at a constant magnitude between about 2.3 V and 3.0 V, for example 2.6 V. In another embodiment, the first bias comprises multiple steps. For example, a first voltage of about 2.0 V is applied for a first time period from about 2-10 seconds, then a second voltage of about 2.6 V is applied for a second time period from about 30 seconds to about 90 seconds, finally, a third voltage of about 2.0 V is applied for a third time period from about 5 seconds to about 20 seconds. In another embodiment, the voltage increases gradually from about 2.0 V to about 2.6 V. In another embodiment, the voltage increases gradually from about 2.0 V to about 2.6 V and then decreases to about 1.8 V.

At step 312, bulk conductive material is removed from at least a portion of the substrate 122 surface by anodic dissolution. The first polishing composition between the substrate 122 and the electrode (not shown) provides a conductive path between the power source (not shown) and the substrate 122 to drive an electrochemical mechanical planarizing process that results in the removal of copper material by anodic dissolution. The process at step 312 generally has a copper removal rate of about 5000 Å/min.

At step 314, a residual electrochemical process is performed on the remaining conductive layer formed on the substrate 122. The residual process step 314 is performed at the second ECMP station 130, but may also be performed on the first ECMP station 128 or the third ECMP station 132. The residual process step 314 generally is terminated when the conductive layer is completely removed from the field area of the substrate 122.

In one embodiment, the residual electrochemical process of step 314 begins at step 316 by exposing the substrate 122 to a second polishing composition. Like the first polishing composition, the second polishing composition may comprise one or more inorganic based electrolytes, one or more chelating agents, one or more corrosion inhibitors, one or more basic pH adjusting agents, a solvent, and one or more oxidizers as discussed above. The second polishing composition may also comprise a dilution of 1-500% of the first polishing composition. The dilution may be performed with a polar solvent such as deionized water, a mixture of deionized water with a corrosion inhibitor such as benzotriazole, a mixture of deionized water with a polymer, such as PEG, PEO, polycarboxylic acid, and polyamide, or a mixture of deionized water with a surfactant such as ADS.

At step 318, the substrate 122 is polished in the second polishing composition. Relative motion is provided between the substrate 122 and a polishing article (not shown). In one embodiment, the planarizing head is rotated at about 10-50 revolutions per minute, while the pad assembly (not shown) is rotated at about 7-35 revolutions per minute.

At step 320, the power source (not shown) provides a second bias voltage to the substrate 122 between the top surface of the pad assembly (not shown) and the electrode (not shown). In one embodiment, the second bias comprises a voltage held at a constant magnitude between about 1.7 V and 2.3 V, for example 2.0 V. In another embodiment, the second bias comprises multiple steps. For example, a first voltage of about 2.2 V is applied for a first time period, a second voltage of 2.1 V is applied for a second time period, a third voltage of about 2.0 V is applied for a third time period, a fourth voltage of about 1.9 V is applied for a fourth time period, a fifth voltage of about 1.8 V is applied for a fifth time period, and a sixth voltage of about 1.7 V is applied for a sixth time period. In another embodiment, the voltage decreases gradually from about 2.2 V to about 1.7 V. In another embodiment, the second bias is pulsed. For example, the second bias comprises a first voltage of about 2.3 V for a first time period between about 2 seconds to about 20 seconds followed by zero volts for a second time period between about 1 second and about 5 seconds, followed by the application of a second voltage greater than zero for a third time period between about 2 seconds to about 20 seconds. In another example, the second bias comprises a first voltage of about 2.3 V applied for a first time period from about 2 seconds to about 10 seconds, followed by the application of a second voltage of about 0.8 V from about 1 second to about 5 seconds. In another example, the second bias comprises a first voltage of about 1.9 V applied for a first time period from about 2 seconds to about 10 seconds, followed by the application of a second voltage of about 1.2 V from about 2 seconds to about 5 seconds.

At step 322, the residual conductive material is removed from at least a portion of the substrate 122 surface by anodic dissolution. The second polishing composition between the substrate 122 and the electrode (not shown) provides a conductive path between the power source (not shown) and the substrate 122 to drive an electrochemical mechanical planarizing process that results in the removal of residual copper material by anodic dissolution. The process at step 322 generally has a copper removal rate of about 1500 Å/min.

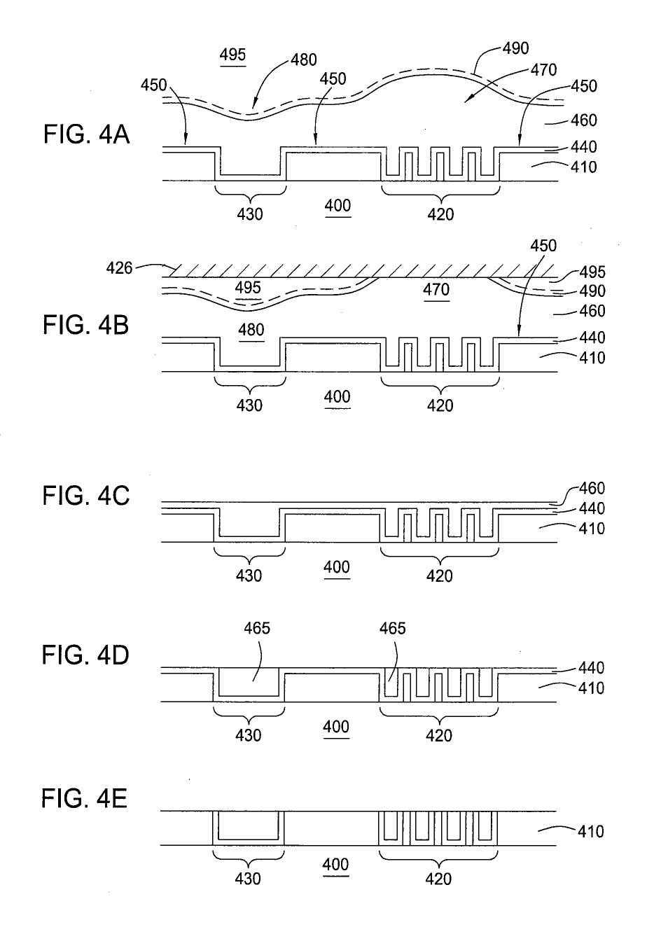

One embodiment of the process will now be described in reference to FIGS. 4A-4E, which are schematic cross-sectional views of a substrate being processed according to methods and compositions described above. The orientation of the substrate has been flipped face-up for ease of explanation, although some systems may process the substrate in this orientation. Referring to FIG. 4A, a substrate generally includes a dielectric layer 410 formed on a substrate 400. A plurality of apertures, such as vias, trenches, contacts, or holes, are patterned and etched into the dielectric layer 410, such as a dense array of narrow feature definitions 420 and low density of wide feature definitions 430. The apertures may be formed in the dielectric layer 410 by conventional photolithographic and etching techniques.

FIG. 4A depicts a substrate 400 and a conductive material 460 with a passivation layer 490 formed thereon before an Ecmp process has been applied. The passivation layer 490 may also be formed as a result from contact with a polishing composition 495. FIG. 4B illustrates the contact of the substrate surface with a polishing article to remove a portion of the passivation layer 490 formed thereon. FIG. 4C illustrates the substrate after a portion of the conductive material 460, such as at least about 50% of the conductive material 460, has been removed by applying a first Ecmp process. The remaining conductive material 460 or residual material disposed upon a barrier layer 440 is removed to the barrier layer 440 by applying a second Ecmp process, as illustrated in FIG. 4D. Furthermore, as illustrated in FIG. 4E, the remaining barrier layer 440 on the dielectric layer 410 may be removed by a third process, such as a CMP process or a third Ecmp process. Alternatively, and not shown, the remaining conductive material 460 and the barrier layer 440 may be removed in a single processing step.

FIG. 4A depicts a substrate 400 and a conductive material 460 with a passivation layer 490 formed thereon before an Ecmp process has been applied. The substrate 400 generally includes a dielectric layer 410 formed on a substrate 400. A plurality of apertures, such as vias, trenches, contacts, or holes, are patterned and etched into the dielectric layer 410, such as a dense array of narrow feature definitions 420 and low density of wide feature definitions 430. The apertures may be formed in the dielectric layer 410 by conventional photolithographic and etching techniques. A barrier layer 440 is formed on the dielectric layer 410. The barrier layer 440 may be ruthenium, tantalum, tantalum nitride, titanium, titanium nitride, and the like. The conductive layer 460 is disposed on the barrier layer 440. The conductive layer 460 may be copper, copper alloys, tungsten, and tungsten alloys, a layer having both tungsten and copper, and the like.

FIG. 4B illustrates electrochemical mechanical polishing during processing. During processing, the substrate surface and a polishing article, such as conductive polishing article disposed in the polishing article assembly, are contacted with one another and moved in relative motion to one another, such as in a relative orbital motion, to remove portions of the passivation layer 490 formed on the exposed conductive material 460, which contact may additionally also remove a portion of the underlying conductive material 460.

FIG. 4C illustrates the substrate after a portion of the conductive material 460, such as at least about 50% of the conductive material 460, has been removed by applying a first Ecmp process. The remaining conductive material 460 or residual material disposed upon a barrier layer 440 is removed to the barrier layer 440 by applying a second Ecmp process, as illustrated in FIG. 4D. Furthermore, as illustrated in FIG. 4E, the remaining barrier layer 440 on the dielectric layer 410 may be removed by a third process, such as a CMP process or a third Ecmp process. Alternatively, and not shown, the remaining conductive material 460 and the barrier layer 440 may be removed in a single processing step.

Referring to FIG. 4D, most, if not all of the conductive material 460 is removed to expose barrier layer 440 and conductive trenches 465 by polishing the substrate with a second Ecmp process for residual removal processing including a second Ecmp polishing composition. The conductive trenches 465 are formed by the remaining conductive material 460.

FIGS. 4C-4D illustrates electrochemical mechanical polishing during processing of the residual conductive material. The electrochemical mechanical polishing process or residual removal includes having the substrate surface and a polishing article, such as conductive polishing article disposed in the polishing article assembly, are contacted with one another and moved in relative motion to one another, such as in a relative orbital motion, and to remove any portions of the optional passivation layers that may formed on the exposed conductive material 460, which contact may additionally also remove a portion of the underlying conductive material 460. Contact between the substrate and a conductive polishing article also allows for electrical contact between the power source and the substrate by coupling the power source to the polishing article when contacting the substrate.

Thus an improved method and composition for electrochemically planarizing a substrate is provided. One polishing composition for both the bulk conductive material removal and the residual conductive material removal is provided. Since this polishing composition can be used for both the high removal rate bulk polish step and the low removal rate residual polish step, the polishing time for both steps can be adjusted so that the majority of the conductive layer is polished at the high removal rate thus reducing total polishing time and improving substrate throughput for the system.

While the foregoing is directed to embodiments of the present invention, other and further embodiments of the invention may be devised without departing from the basic scope thereof, and the scope thereof is determined by the claims that follow.

1. A composition for electrochemical mechanical polishing of a substrate surface comprising a conductive material, the composition having a pH of between about 3.0 to about 9.0, the composition initially comprising:
one or more inorganic based electrolytes;
one or more chelating agents;
one or more corrosion inhibitors;
one or more basic pH adjusting agents;
one or more oxidizers; and
a solvent.

2. The composition of claim 1, initially comprising:
between about 4.0 to about 15.0 wt. % of the one or more inorganic based electrolytes;
between about 0.4 to about 2.5 wt. % of the one or more chelating agents;
between about 0.1 to about 0.4 wt. % of the one or more corrosion inhibitors;
an amount of one or more basic pH adjusting agents sufficient to achieve a pH of between about 3.0 to about 9.0;
between about 0.01 to about 1.0 wt. % of the one or more oxidizers; and
the remainder substantially deionized water.

3. The composition of claim 2, wherein:
at least one of the one or more inorganic based electrolytes has a phosphate group;
at least one of the one or more chelating agents has one or more carboxylate functional groups;
at least one of the one or more corrosion inhibitors has an azole group;
at least one of the one or more oxidizers is hydrogen peroxide or ammonium persulphate; and
at least one of the one or more pH adjusting agents has a hydroxide group.

4. The composition of claim 1, further comprising between about 0.001 to about 3.0 wt. % of silica abrasive particles.

5. The composition of claim 4, wherein the silica abrasive particles have a particle size between about 5 to about 100 nm.

6. The composition of claim 2, wherein the at least one or more chelating agents comprise between about 0.2 to about 3.0 wt. % of a chelating agent having an amine functional group.

7. The composition of claim 6, wherein the chelating agent having an amine group is selected from a group comprising imidodiacetic acid and glycine.

8. The composition of claim 2, comprising:
between about 8.0 to about 13.0 wt. % of potassium phosphate monobasic;
between about 1.0 to about 2.5 wt. % of citric acid or salts thereof;
between about 0.3 wt. % of benzotriazole;
an amount of one or more pH adjusting agents sufficient to achieve a pH of between about 3.0 to about 9.0;
between about 0.01 to about 1.0 wt. % of hydrogen peroxide; and
the remainder substantially deionized water.

9. The composition of claim 8, comprising between about 0.5 to about 1.5 wt. % of the chelating agent, wherein the chelating agent is selected from the group consisting of glycine, imidodiacetic acid, and combinations thereof.

10. The composition of claim 8, further comprising between about 0.01% to about 1 wt. % of silica abrasives.

11. A composition for electrochemical mechanical polishing of a substrate surface comprising a conductive material, the composition having a pH of between about 3.0 to about 9.0, the composition produced by a process comprising:
combining a phosphoric acid based electrolyte system with one or more chelating agents, one or more corrosion inhibitors, one or more oxidizers, and a solvent; and
adding one or more basic pH adjusting agents to the phosphoric acid based electrolyte system to achieve a pH between about 3.0 and about 9.0.

12. The composition of claim 11, wherein the phosphoric acid based electrolyte system comprises a phosphoric acid, or a phosphoric acid salt selected from the group consisting of potassium phosphate (KₓPO₄), copper phosphate, ammonium dihydrogen phosphate ((NH₄)₂H₂PO₄), diammonium hydrogen phosphate ((NH₄)HPO₄), wherein x is selected from the group of 1, 2, or 3.

13. The composition of claim 11, wherein the one or more corrosion inhibitors have one or more azole groups.

14. The composition of claim 11, wherein the one or more corrosion inhibitors are selected from the group consisting of benzotriazole, imidazole, benzimidazole, triazole, and derivatives of benzotriazole, imidazole, benzimidazole, triazole, with hydroxy, amino, imino, carboxy, mercapto, nitro and alkyl substituted groups, and combinations thereof.

15. The composition of claim 11, wherein the one or more basic pH adjusting agents comprise one or more bases selected from the group consisting of potassium hydroxide, ammonium hydroxide, and combinations thereof.

16. The composition of claim 11, wherein the composition further comprises an abrasive selected from the group consisting of inorganic abrasives, polymeric abrasives, polymeric coated abrasives, and combinations thereof.

17. The composition of claim 11, further comprising adding one or more oxidizers selected from the group consisting of peroxy compounds, salts of peroxy compounds, organic peroxides, sulfates, derivatives of sulfates, compounds containing an element in the highest oxidation state, and combinations thereof to the phosphoric acid based electrolyte system.

18. The composition of claim 11, wherein the one or more chelating agents further comprises a second chelating agent having an amine group.

19. The composition of claim 18, wherein the second chelating agent is selected from the group consisting of imidodiacetic acid and glycine.

20. The composition of claim 11, wherein the composition is formed by combining:
between about 4.0 to about 15.0 wt. % of one or more inorganic based electrolytes;
between about 0.4 to about 2.5 wt. % of the one or more chelating agents;
between about 0.1 to about 0.4 wt. % of one or more corrosion inhibitors;
an amount of basic pH adjusting agent sufficient to achieve a pH of between about 3.0 to about 9.0;
between about 0.01 to about 1.0 wt. % of one or more oxidizers; and
the remainder substantially deionized water.
